(19) United States
(12) Patent Application Publication
(10) Pub. No.: US 2008/0100867 A1
(43) Pub. Date: May 1, 2008

(54) Image saving system

(75) Inventor: Koji Nakao, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/973,047

(22) Filed: Oct. 4, 2007

(30) Foreign Application Priority Data
Oct. 4, 2006 (JP) 2006-272677
Sep. 12, 2007 (JP) 2007-236835

(51) Int. Cl. G06F 15/00

(52) U.S. Cl. 358/1.15; 348/552; 358/1.6

(57) ABSTRACT

A technique of printing content transmitted when a printing apparatus is in a failure state via data broadcasting is printed after the printing apparatus is recovered from the failure state is provided. The printing apparatus includes an obtaining unit for obtaining script which describes about the content in accordance with the XML standard and reference image data which is referred by the script, a script interpreter for interpreting the script, and a content storing unit. The obtaining unit obtains the reference image data from a reference destination in accordance with a result of interpreting of the script obtained using the script interpreter when receiving a request for printing with the script. The script interpreter corrects the script so that the reference destination of the reference image data is changed to the content storing unit, and the corrected script and the reference image data are stored in the content storing unit.

### BACKGROUND OF THE INVENTION

1. Technical Field

The present invention relates to a technique of printing content transmitted through data broadcasting.

2. Background Art

In digital television broadcasting, content including still images and character strings relating to a program is transmitted through data broadcasting. A digital television receiver (“hereinafter referred to as a “DTV”) displays the content to be transmitted through the data broadcasting, and may display a print button used to print the content. When a user presses the print button by operating a remote controller, for example, the content is printed using a printer connected to the DTV. Patent Document 1 discloses an example of a digital content printing system serving as a system for printing content transmitted through data broadcasting as described above.

Patent Document 1: Japanese Unexamined Patent Application Publication No. 2004-159245

### DISCLOSURE OF INVENTION

In a system for printing content transmitted through data broadcasting, in a case where a printer runs out of ink or failure occurs in a printer and therefore a printing operation is not performed, even when a print button of a DTV is pressed, the content is not printed. Furthermore, in a case where it takes a long time for the printer to recover to a printable state by supplying the ink, for example, a program may be changed to a next one and the print button may disappear, and therefore, desired content may not be printed. Even in a case where the print button does not disappear, content relating to the next program may be printed, and therefore, the desired content may not be printed.

An object of the present invention is to provide a technique of printing content after a printing apparatus is recovered from a failure, the content being transmitted through data broadcasting when the printing apparatus is in a failure state.

To this end, there is provided a printing apparatus which prints content including an image, the printing apparatus including an obtaining unit configured to obtain script which describes about the content in accordance with the XML standard and reference image data which is referred by the script, a script interpreter configured to interpret the script, and a content storing unit. The obtaining unit obtains the reference image data from a reference destination in accordance with a result of interpreting of the script obtained using the script interpreter when receiving a request for printing including the script. The script interpreter corrects the script so that the reference destination of the reference image data is changed to the content storing unit, and the corrected script and the reference image data are stored in the content storing unit.

In the printing apparatus, since the script included in the request for printing is interpreted, the reference image data is obtained from the reference destination, the script is corrected so that the reference destination of the reference image data is changed to the content storing unit, and the corrected script and the reference image data are stored in the content storing unit, the content transmitted via the data broadcasting can be printed in accordance with the script and the image data stored in the content storing unit a long period of time after the request for printing is received.

The printing apparatus may further include a management unit configured to manage an operation state of the printing apparatus. The script interpreter may obtain the operation state of the printing apparatus from the management unit, and when the printing apparatus is in an immediate-printing impossible state in which the printing apparatus cannot perform processing immediately in accordance with the request for printing, the corrected script and the reference image data may be stored in the content storing unit, whereas when the printing apparatus is not in the immediate-printing impossible state, the corrected script and the reference image data may not be stored in the content storing unit.

With this configuration, even if a period of time in which the reference image data can be obtained coincides with a period of time in which the processing cannot be performed immediately in accordance with the request for printing, the content can be printed by performing the processing in accordance with the request for printing after the printing apparatus becomes able to perform processing in accordance with the request for printing.

In the printing apparatus, the immediate-printing impossible state may be a failure state.

With this configuration, even if the period of time in which the reference image data can be obtained coincides with a period of time in which the printing apparatus is in the failure state due to out of sheets or out of ink, for example, the content can be printed by performing the processing in accordance with the request for printing after the printing apparatus is recovered from the failure state by supplying sheets for printing or ink.

In the printing apparatus, the content storing unit may store the corrected script and the reference image data even after the content is printed.

With this configuration, even after the printing apparatus is recovered from the failure state and prints the content, the content can be printed again in an arbitrary timing on the basis of the reference image data and the corrected script stored in the content storing unit.

The printing apparatus may further includes an image processor configured to resize an image represented by the reference image data in accordance with a size of a sheet for printing specified by the request for printing. The script interpreter may control the content storing unit to store therein image data representing the resized image as the reference image data.

With this configuration, since reference image data is stored after being resized, the reference image does not need to be resized when the content is printed after the printing apparatus is recovered from the failure state. Accordingly, the printing of the content is completed in relatively short period of time after the printing apparatus is recovered from the failure state. Furthermore, in a case where a size of the data becomes smaller than that of the original reference image data by the resizing operation, a larger amount of reference image data can be stored in the content storing unit when compared with a case where the reference image data is stored without being subjected to the resizing operation.

The printing apparatus may further include a first user interface including a content list display unit used to display a list of pieces of content each of which includes the corrected script and the reference image data which are stored in the content storing unit, a button used to print one of the pieces of content selected from the list, and a button used to delete the corrected script and the reference image data of the one of the pieces of content selected from the list.

With this configuration, a user can print desired content in a desired timing or delete the corrected script and the reference image data which is no longer used in a desired timing using the first user interface.

The printing apparatus may further include a printing executing unit configured to print the content in accordance with the result of interpreting of the script obtained using the script interpreter, and a second user interface. The printing executing unit includes as printing modes used when the content is printed, (i) a normal printing mode, and (ii) a draft printing mode which attains printing cost lower than that of the normal printing mode. The second user interface is used to select one of the printing modes.

With this configuration, the content can be printed at a relatively low cost when the user selects the draft printing mode as a printing mode using the second user interface. Therefore, the user can check the content printed in the draft printing mode and determines whether the printing operation is performed in the normal printing mode at relatively high printing cost. Accordingly, content which does not need to be printed in the normal printing mode is not printed in the normal printing mode and consumable supplies used in the printing operation is prevented from being unnecessarily used.

The printing apparatus may further include a printing executing unit configured to print the content in accordance with the result of interpreting of the script obtained using the script interpreter, and a third user interface. The printing executing unit may include as printing modes used when the content is printed, (i) a normal printing mode, and (ii) a draft printing mode which attains printing cost lower than that of the normal printing mode. The third user interface may be used to determine whether the corrected script and the reference image are stored in the content storing unit after the printing executing unit prints the content in the draft printing mode.

With this configuration, the user can check a result of the printing operation in the draft printing mode, and determine whether the content is stored in the content storing unit, and further confirm the determination as to whether the content is stored in the content storing unit using the third user interface. Accordingly, content which does not need to be stored is not stored and a storage area of the content storing unit is prevented from being unnecessarily used.

In the printing apparatus, the printing executing unit may perform printing using a predetermined sheet for printing of a relatively large size irrespective of a size of a sheet for printing specified by the request for printing when printing the content in the draft printing mode.

With this configuration, the content can be printed in the draft printing mode without intruding from a sheet, and the user can recognize a size of the content after being printed. Accordingly, before the printing operation is performed in the normal printing mode, a sheet for printing of an appropriate size can be prepared in the printing apparatus.

Note that the present invention may be implemented by various forms. For example, the present invention may be implemented as a content printing method, a computer program used for realizing functions of the printing apparatus or the content printing method, a recording medium which stores the computer program therein, or a data signal which includes the computer program and which is implemented in a carrier wave.

### BRIEF DESCRIPTION OF THE DRAWINGS

FIG. 1 is a diagram schematically illustrating a configuration of a digital content printing system including a printer according to an embodiment of the present invention.

FIG. 2 is a diagram illustrating an internal configuration of a printer 100 shown in FIG. 1.

FIG. 3 is a flowchart illustrating a procedure of a printing operation for printing content to be printed performed using the printer 100.

FIG. 4 is a diagram illustrating description of a script 301.

FIG. 5 is a diagram illustrating a resizing table 31 stored in a memory 30.

FIG. 6 is a diagram illustrating description of the corrected script 301.

FIG. 7 is a flowchart illustrating a procedure of a printing operation for printing content to be printed according to a second embodiment.

FIG. 8 is a diagram schematically illustrating a configuration of a digital content printing system according to a third embodiment.

FIG. 9 is a diagram illustrating a content list screen displayed on a display unit 15 of a printer 100 according to a fourth embodiment.

FIG. 10 is a flowchart illustrating a procedure of a printing operation for printing content to be printed according to a fifth embodiment.

FIG. 11 is a diagram illustrating a test printing determination menu screen displayed in step S605.

FIG. 12 is a diagram illustrating a content deleting determination menu screen displayed in step S615.

FIG. 13 is a flowchart illustrating a procedure of a printing operation for printing content to be printed according to a sixth embodiment.

FIG. 14 is a flowchart illustrating a procedure of a printing operation for printing content to be printed according to a sixth embodiment.

FIG. 15 is a diagram illustrating a printing determination menu screen displayed in step S705.

FIG. 16 is a diagram illustrating a content storing determination menu screen displayed in step S715.

### REFERENCE NUMERALS

10 CPU
10a printer management unit
10b printing controller
10c image processor
10d script interpreter
12 hard disc drive
12a script storing unit
12b image data storing unit
13 printer engine
14 operation unit
15 display unit
16 network interface unit
20 control circuit
30 memory
31 resizing table
100 printer
201 memory
301 script
302 image data
500 content server
1000 digital content printing system
1100 digital content printing system
W1 television screen
B1 print button
f1 still image
p1 content to be printed
W2 content list screen
W3 printing determination menu screen
W4 content deleting determination menu screen
W5 printing determination menu screen
W6 content storing determination menu screen
TA program display section
BW content display section
B21 to B23 content specifying button
B33 print button
B34 deleting button
B35 back button
B51, B61, B71, B81 enter button
B52, B62, B72, B82 cancelling button
B53, B63, B73, B83 radio button group
INT the Internet

### BEST MODE FOR CARRYING OUT THE INVENTION

Preferred embodiments of the present invention will be described hereinafter in the following order.

A. First embodiment

B. Second embodiment

C. Third embodiment

D. Fourth embodiment

E. Fifth embodiment

F. Sixth embodiment

G. Modifications

### A. First Embodiment

A1. System Configuration

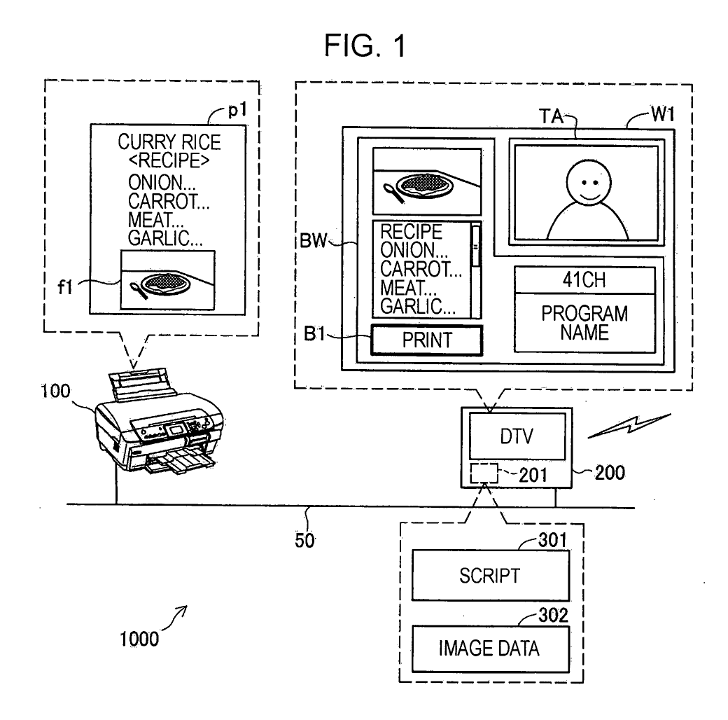

FIG. 1 is a diagram schematically illustrating a configuration of a digital content printing system including a printer according to an embodiment of the invention. A digital content printing system 1000 includes a printer 100 and a DTV 200 connected to the printer 100 via a local area network (hereinafter referred to as a “LAN”) 50. The LAN 50 may be a wired network employing the IEEE802.3 standard, for example, or may be a wireless network employing the IEEE802.11b/g/a standard, for example.

The printer 100 and the DTV 200 are network apparatuses compatible with a universal plug and play (hereinafter referred to as a “UPnP” which is a trademark of UPnP Implementers Corporation). Note that the UPnP has an architecture designed so that the network apparatuses are connected to/disconnected from the network in a desired timing. A UPnP network includes a control point and a device. The “device” is an apparatus which provides service. The “device” and a “service device” are used as equivalent terms unless otherwise instructed herein. The “control point” is a controller used to detect and control another device connected to the network, and serves as a client for the service device. In the digital content printing system 1000, the DTV 200 functions as the control point, and the printer 100 functions as the service device which provides printing service to the control point. Note that the digital content printing system 1000 may include another network apparatus which is compatible with the UPnP or another network apparatus which is not compatible with the UPnP.

The DTV 200 displays a program of digital television broadcasting and content received through data broadcasting. Specifically, a television screen W1 of the DTV 200 includes a program display section TA and a content display section BW. The program is displayed in the program display section TA, and a still image and character strings, for example, relating to the program are displayed in the content display section BW. In the data broadcasting, in addition to data representing content to be displayed, data representing content to be printed may be transmitted. In this case, the data representing the content to be printed is stored in a memory 201 included in the DTV 200. When the data representing the content to be printed is stored in the memory 201, a print button B1 used to print the content to be printed is displayed in the content display section BW. When a user operates a remote controller, for example, so as to press the print button B1, script used to print the content to be printed is generated in the DTV 200 and is stored in the memory 201. Thereafter, in the digital content printing system 1000, the script is transmitted to the printer 100, and the content to be printed is printed in accordance with the script.

In an example of FIG. 1, image data 302 and script 301 which includes description of the content to be printed including the image data 302 as a reference image are stored in the memory 201 of the DTV 200. The printer 100 prints content p1 to be printed including a still image f1 representing the image data 302 in accordance with the script 301. Note that, although the script 301 is XHTML-Print script in this embodiment, any script may be used as long as the script has an arbitrary format based on the XML standard such as a MIME (Multipurpose Internet Mail Extension) format.

Here, pieces of data representing pieces of content to be printed received through the data broadcasting are successively used to overwrite pieces of previous data, and are stored in the memory 201. Accordingly, when channels are switched from a first program to a second program or when a first program is changed to a second program in a next time slot, the image data 302 which has been received is overwritten by data representing content to be printed relating to the second program, for example, so that the data representing content to be printed relating to the second program is stored.

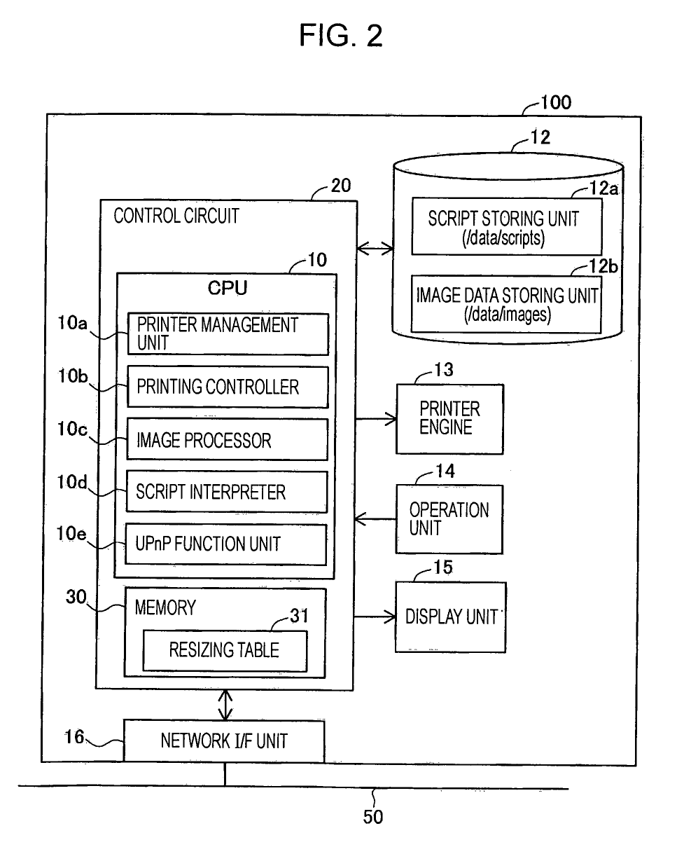

FIG. 2 is a block diagram illustrating an internal configuration of the printer 100 shown in FIG. 1. The printer 100 includes a control circuit 20, a hard disc drive 12, a printer engine 13, an operation unit 14 having buttons and a touch panel, for example, a display unit 15 having a liquid crystal panel, for example, and a network interface unit 16. The printer engine 13 is a printing system which performs a printing operation in accordance with printing data.

The control circuit 20 includes a CPU 10 and a memory 30. The memory 30 stores therein a resizing table 31, which will be described later, and various programs used to control operations performed using the printer 100. The CPU 10 functions as a printer management unit 10a by performing the various programs stored in the memory 30, and further functions as a printing controller 10b, an image processor 10c, a script interpreter 10d, and a UPnP function unit 10e. The printer management unit 10a obtains information about a remaining amount of ink, for example, from the printer engine 13, and checks whether the printer 100 is in a state in which the printer 100 cannot perform a printing operation (hereinafter referred to as a “failure state”). Note that in the failure state, although the printer 100 cannot perform the printing operation, the printer 100 can perform data communication with the DTV 200 through the LAN 50. The printing controller 10b controls the printer engine 13 to perform the printing operation in accordance with printing data. The image processor 10c performs a resizing operation (of changing the number of pixels by performing an interpolating operation, for example) on an image. The script interpreter 10d interprets script generated on the basis of the XML standard. The UPnP function unit 10e executes various protocols prescribed by the UPnP and functions as a service device for the UPnP.

The hard disc drive 12 includes a script storing unit 12a and an image data storing unit 12b. In the printer 100 configured as a file system, the script storing unit 12a indicates an absolute directory “/data/scripts” and the image data storing unit 12b indicates an absolute directory “/data/images”.

Note that the UPnP function unit 10e corresponds to an obtaining unit in Claims, and the script storing unit 12a and the image data storing unit 12b correspond to a content storing unit in Claims.

A2. Printing Operation for Content to be Printed

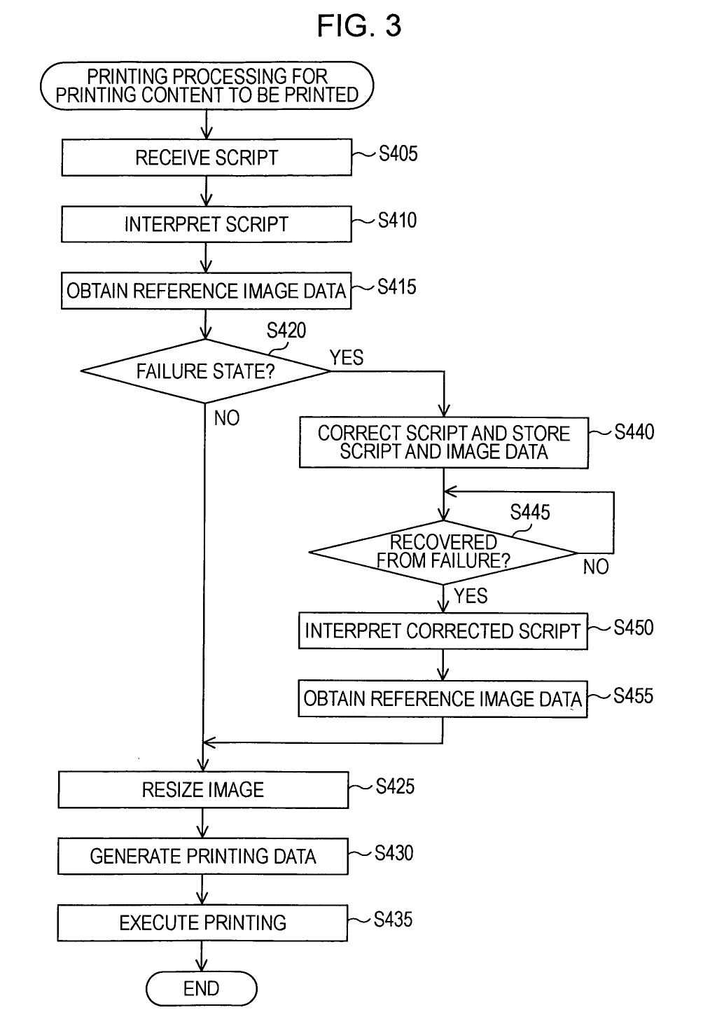

FIG. 3 is a flowchart illustrating a procedure of a printing operation for printing content to be printed using the printer 100. In a state in which the image data 302, which represents the content to be printed, is stored in the memory 201 of the DTV 200 (as shown in FIG. 1), when the user presses the print button B1, the script 301 used for the printing operation is generated and is stored in the memory 201. Furthermore, a request for printing including the script 301 is transmitted to the printer 100. The request for printing is transmitted through a “control” operation prescribed by the UPnP. The “control” operation is an operation of transmitting a control message including an action request to a device (the printer 100) and controlling the device using the control point (the DTV 200). The “control” operation is performed using HTTP/SOAP. When the request for printing is transmitted, the printer 100 performs the printing operation for printing the content to be printed.

When the printing operation for printing the content to be printed is started, the UPnP function unit 10e (shown in FIG. 2) receives the script 301 and controls the memory 30 to store the script 301 in step S405. In step S410, the script interpreter 10d interprets the received script 301.

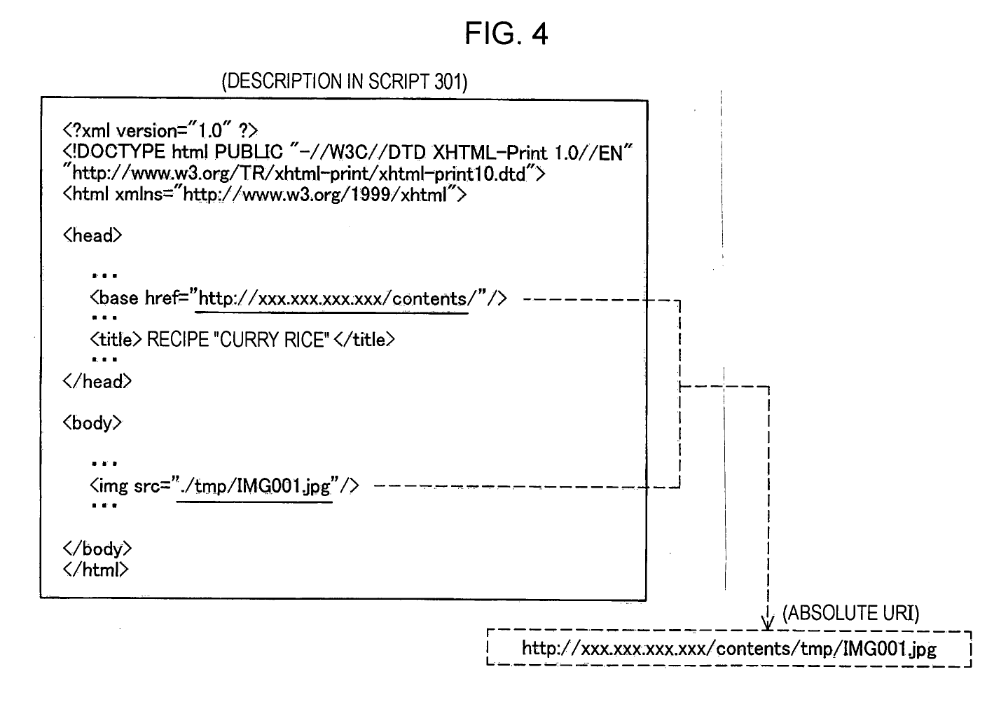

FIG. 4 is a diagram illustrating description of a script 301. In the script 301, the image data 302 (a file name: “IMG001.jpg”) is referred using a tag <img src>. Here, the image data 302 is referred using a relative URI (Uniform Resource Identifier), and a reference URI for the relative URI is specified using a <base href> tag (http://xxx.xxx.xxx.xxx/contents/). Accordingly, an absolute URI of the image data 302 is “http://xxx.xxx.xxx.xxx/contents/tmp/IMG001.jpg”. Note that the absolute URI indicates the image data 302 stored in the memory 201 of the DTV 200. Thereafter, the script interpreter 10d specifies the absolute URI so as to request the UPnP function unit 10e to obtain the image data 302.

In step S415 (in FIG. 3), the UPnP function unit 10e obtains the image data 302 from the DTV 200 in accordance with the specified absolute URI, and the obtained image data 302 is stored in the memory 30. In step S420, the script interpreter 10d communicates with the printer management unit 10a so as to determine whether the printer 100 is in the failure state. When it is determined that the printer 100 is not in the failure state, steps S425, S430, and S435 are performed so that the printing operation is performed. In step S425, the image processor 10c resizes an original image (the still image f1 shown in FIG. 1) represented by the image data 302 so that a size of the image becomes equal to or smaller than a size of a sheet specified by the script 301. Here, the image processor 10c performs the resizing operation using the resizing table 31 stored in the memory 30.

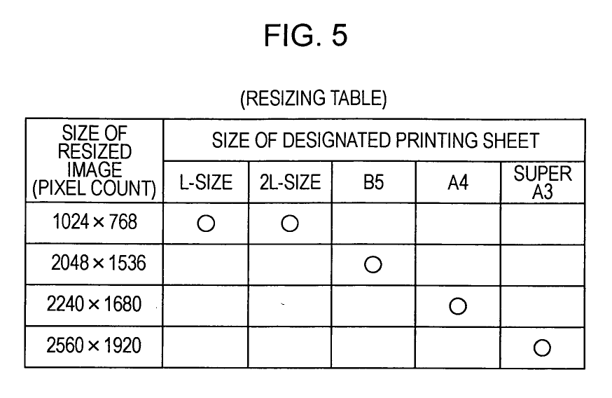

FIG. 5 is a diagram illustrating a resizing table 31 stored in the memory 30. In the resizing table 31, the relationships between sizes of the sheet for printing and sizes of the resized image are shown. Each of the sizes of the resized image associated with the sizes of the sheet for printing is equal to or smaller than a corresponding one of the sizes of the sheet for printing used for the printing operation. For example, in the script 301, when an “A4” size is specified as a size of the sheet for printing, the still image f1 is resized so as to have 2240×1680 pixels in step S425. Note that in a case where a size of the original image is smaller than the size of the resized image prescribed in the resizing table 31, the resizing operation is not performed and the size of the original image is retained.

In step S430 (in FIG. 3), the printing controller 10b generates printing data representing the content p1 to be printed (shown in FIG. 1) in accordance with the data representing the resized image and the script 301 interpreted in step S410. Then, in step S435, the printing controller 10b controls the printer engine 13 to print the content p1 to be printed on the basis of the generated printing data. Note that in a case where the size of the original image is controlled in step S430 so that a size of an image which is to be output as a final image is attained, step S425 may be eliminated.

On the other hand, when it is determined that the printer 100 is in the failure state in step S420, the script interpreter 10d corrects the script 301, stores the corrected script 301 in the script storing unit 12a, and reads the image data 302 from the memory 30 so as to store the image data in the image data storing unit 12b (step S440).

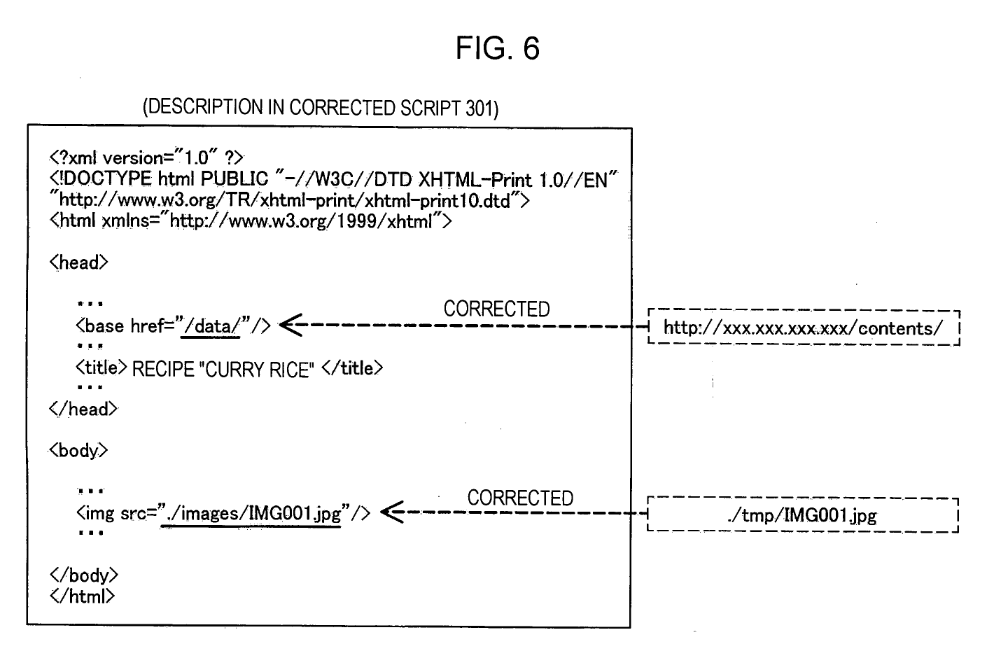

FIG. 6 is a diagram illustrating description of the corrected script 301. In the corrected script 301, the reference URI is corrected so as to indicate a directory “/data/” in the hard disc drive 12, and the relative URI of a reference image data (the image data 302) is corrected so as to indicate “./images/IMG001.jpg”. Consequently, according to the corrected script 301, the absolute URI of the image data 302 is “/data/images/IMG001.jpg”, and the image data 302 stored in the image data storing unit 12b (shown in FIG. 2) is referred.

In step S445 (in FIG. 3), the script interpreter 10d periodically communicates with the printer management unit 10a so as to obtain an operation state of the printer 100, and determines whether the printer 100 is recovered from the failure. Note that the printer management unit 10a may autonomously inform the script interpreter 10d of the operation state of the printer 100 and the printer management unit 10a may detects a change of the operation state of the printer 100 whereby the determination as to whether the printer 100 is recovered from the failure may be made. When it is determined that the printer 100 is recovered from the failure, the script interpreter 10d interprets the corrected script 301, specifies the absolute URI of a reference image, and requests the UPnP function unit 10e to obtain the image data 302 (step S450).

In step S455, the UPnP function unit 10e obtains the image data 302 with reference to the specified URI. Since the specified absolute URI is “/data/images/IMG001.jpg” as described above, the UPnP function unit 10e reads the image data 302 from the hard disc drive 12 included in the printer 100. When the processing in step S455 is completed, steps S425, S430, and S435 described above are performed so that the content p1 to be printed is printed.

As described above, in the digital content printing system 1000, when the printer 100 is in the failure state, the image data 302 which is referred by the script 301 is obtained from a reference destination, and the corrected script 301 and the image data 302 are stored in the hard disc drive 12. After the printer 100 is recovered from the failure, content to be printed is printed on the basis of the corrected script 301 and the image data stored in the hard disc drive 12. Accordingly, even when a long period of time is necessary for recovering the printer 100 from the failure, and therefore, the print button B1 is disappeared from the DTV 200 since another program is broadcasted, the content p1 to be printed is printed.

### B. Second Embodiment

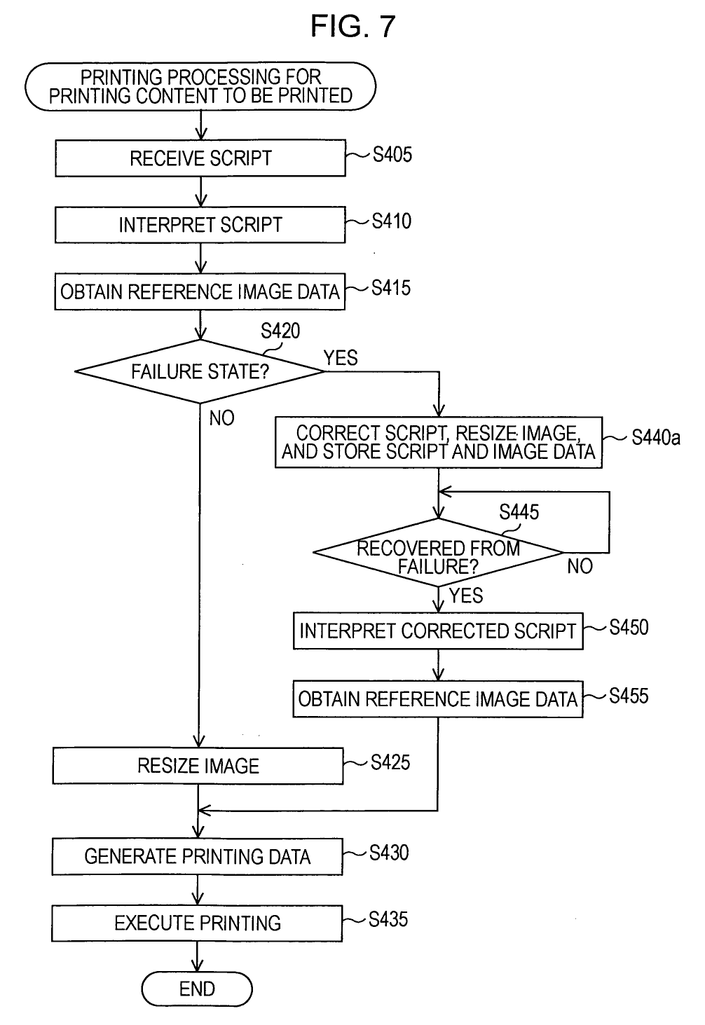

FIG. 7 is a flowchart illustrating a procedure of a printing operation for printing content to be printed according to a second embodiment. The procedure of the second embodiment is different from the procedure shown in FIG. 3 in that an operation performed in step S440 of FIG. 3 is modified and step S430 is performed after step S455. Other steps of the procedure of the second embodiment are the same as those of the first embodiment. In step S440 of the first embodiment, the image data 302 obtained from the DTV 200 is stored in the image data storing unit 12b as it is. However, in this embodiment, obtained image data 302 is resized in advance and thereafter the resized image data 302 is stored in an image data storing unit 12b. Note that a configuration of a digital content printing system is the same as that of the digital content printing system 1000 shown in FIG. 1.

In step S440a of FIG. 7, an image processor 10c reads the image data 302 from a memory 30 and performs a resizing operation using a resizing table 31 (shown in FIG. 5). A script interpreter 10d controls the image data storing unit 12b to store the resized image data 302 therein, corrects script 301, and controls a script storing unit 12a to store the corrected script 301 therein. In a case where it is determined that a printer 100 has recovered from the failure, steps S445, S450, and S455 described above are performed, step S425 is skipped, and steps S430 and S435 are performed. Here, since a resizing operation is performed in step S440a, step S425 is skipped. Note that even when it is determined that the printer 100 is not in the failure state in step S420, step S425 may be skipped if the size of the original image is controlled so that an image which is to be output as a final image is attained in step S430.

With this configuration, the printing operation is performed without performing the resizing operation after the printer 100 is recovered from the failure. Accordingly, the printing operation for printing the content to be printed is completed in a relatively short time after the printer 100 is recovered from the failure. Furthermore, since a size of the resized data is equal to or smaller than a size of data corresponding to the original image, a larger amount of image data (files) can be stored in the image data storing unit 12b when compared with a case where the image data is stored without being subjected to the resizing operation.

### C. Third Embodiment

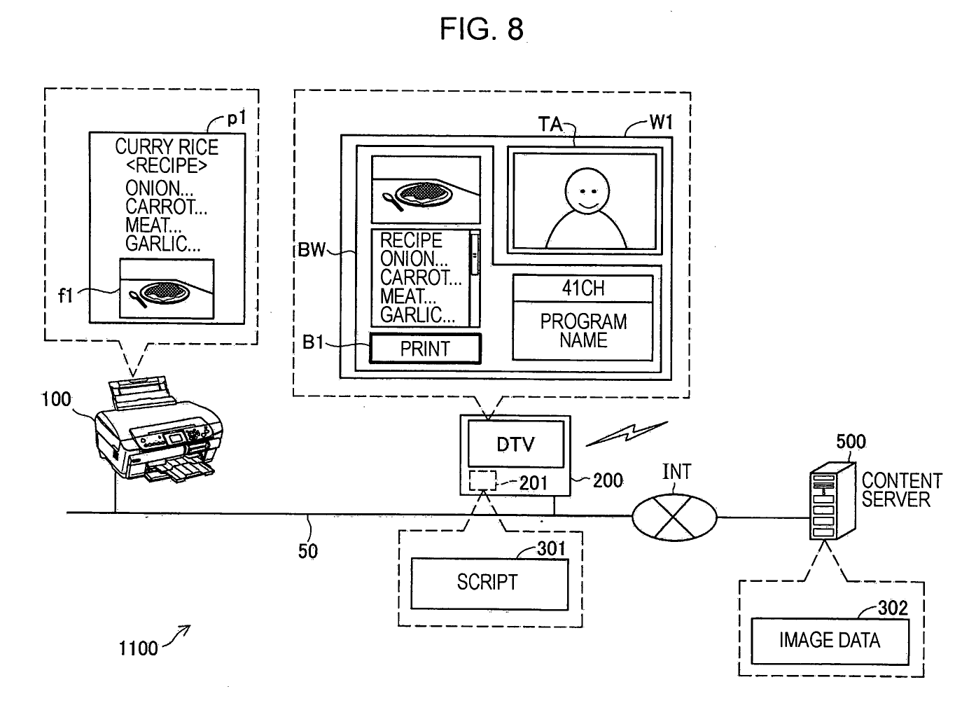

FIG. 8 is a diagram schematically illustrating a configuration of a digital content printing system according to a third embodiment. A digital content printing system 1100 is different from the digital content printing system 1000 shown in FIG. 1 in that the digital content printing system 1100 is connected to a content server 500 of a digital television broadcasting station via the Internet INT, and other points of the configuration are the same as those of the digital content printing system 1000. In the embodiments described above, the image data 302 is transmitted from the DTV 200 to the printer 100. However, in the third embodiment, image data 302 is transmitted from the content server 500 to a printer 100.

Specifically, a DTV 200 receives, instead of the image data 302, a URI of the image data 302 stored in the content server 500 via data broadcasting. In the DTV 200, script 301 in which the URI is described as a reference direction of the image data 302 is generated and is transmitted to the printer 100. Then, a UPnP function unit 10e of the printer 100 obtains the image data 302 from the content server 500 in accordance with the URI in step S415 (in FIGS. 3 and 7).

With this configuration, as with the embodiments described above, the printer 100 can obtain the image data 302 which is content data used for a printing operation. Furthermore, in a case where the image data 302 is stored in the content server 500 within a broadcast time of a program and the printer 100 is recovered from the failure after the broadcast time of the program, since the printer 100 obtains the image data 302 within the broadcast time of the program, the printer 100 can print content to be printed including the image data 302.

### D. Fourth Embodiment

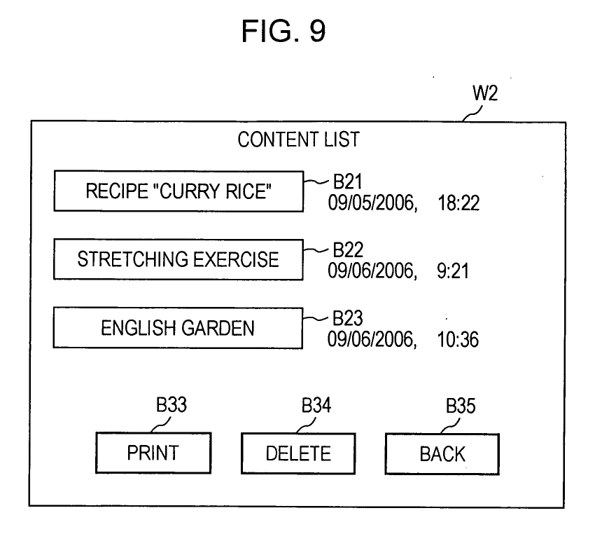

FIG. 9 is a diagram illustrating a content list screen displayed on a display unit 15 of a printer 100 according to a fourth embodiment. In the embodiments described above, after the printer 100 is recovered from the failure, printing of the content to be printed is performed as one step of the printing operation for printing the content to be printed (step S435). In the fourth embodiment, in addition to the printing in such timing, the content to be printed may be printed in arbitrary timing after the printing operation for printing the content to be printed is terminated.

In the printer 100, when a user selects a content list display menu from an initial menu (not shown) displayed in a display unit 15 (in FIG. 2), a content list screen W2 is displayed in the display unit 15 as shown in FIG. 9. The content list screen W2 includes content specifying buttons B21 to B23, a print button B33, a deleting button B34, and a back button B35. Titles of pieces of content to be printed which are stored in a hard disc drive 12 are shown in the corresponding content specifying buttons B21 to B23. Dates and times when the pieces of content are stored in the hard disc drive 12 are shown beside the corresponding titles of the pieces of content to be printed. Note that the content specifying buttons B21 to B23 correspond to a content list display unit in Claims and the content list screen W2 corresponds to a first user interface in Claims.

In an example shown in FIG. 9, three pieces of content to be printed are stored in the hard disc drive 12, and the content specifying buttons B21 to B23 corresponding to the three pieces of content to be printed are displayed in the content list screen W2. Here, the content to be printed represented by the content specifying button B21 corresponds to a content p1 to be printed shown in FIG. 1. When the user wishes to print the content p1 to be printed again after the printing operation for printing the content to be printed as described above is performed, the user operates an operation unit 14 (in FIG. 2) so as to select the content specifying button B21 and presses the print button B33. By this, steps S450 and S455, and steps S425, S430, and S435 (or steps S430 and S435) are performed so that the content p1 to be printed is printed.

Note that the titles assigned to the content specifying buttons B21 to B23 are displayed using character strings described in corrected script. Specifically, for example, a character string specified by a <title> tag in corrected script 301 (in FIG. 6) is displayed as the title assigned to the content specifying button B21. When the user operates the operation unit 14 so as to select one of the content specifying buttons B21 to B23 and presses the deleting button B34 (in FIG. 9), the corrected script for the content to be printed which is specified by the user is deleted from a script storing unit 12a, and image data corresponding to the content to be printed which is specified by the user is deleted from an image data storing unit 12b.

With this configuration, the user can specify and print content to be printed again even after the printing operation for printing the content to be printed is completed. Furthermore, the user can delete content to be printed which is no longer used from the hard disc drive 12 in arbitrary timing.

Note that when it is determined that the printer 100 is in the failure state in step S420 (in FIGS. 3 and 7), the printing operation for printing the content to be printed may be terminated without performing step S445 and the following steps after steps S440 or S440a is performed. In this case, as described above, the content to be printed may be printed only when a printing instruction is issued using the content list screen W2.

### E. Fifth Embodiment

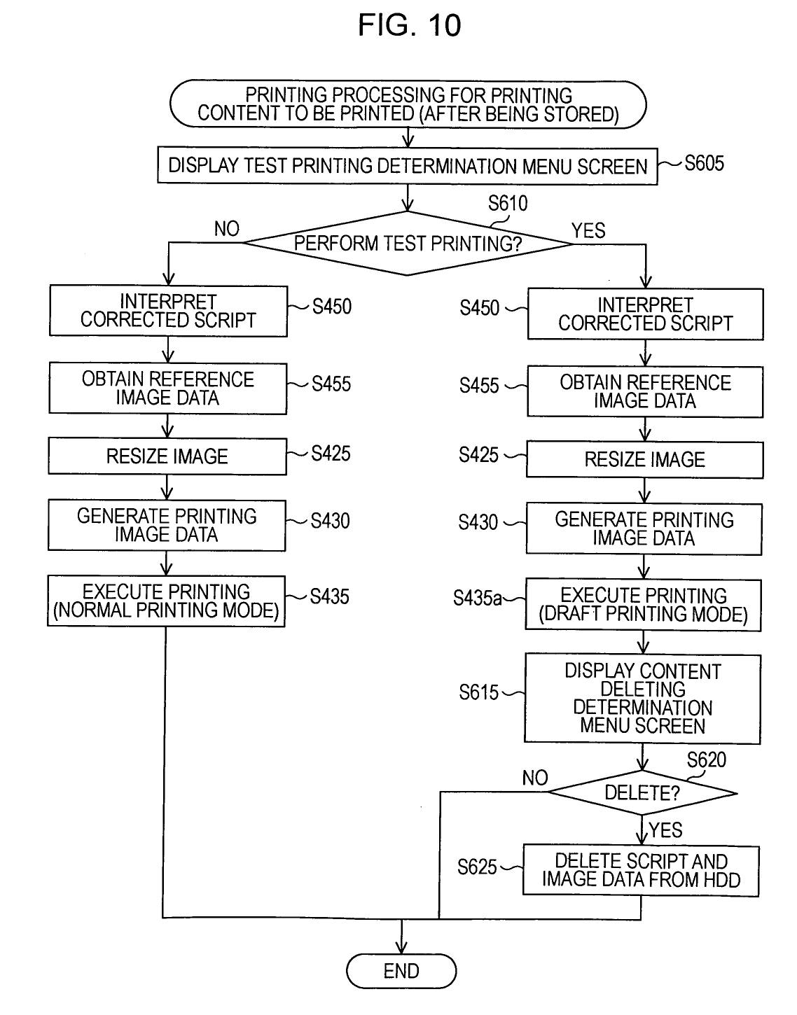

FIG. 10 is a flowchart illustrating a procedure of a printing operation for printing content to be printed according to a fifth embodiment. A printer of the fifth embodiment is different from the printer 100 of the fourth embodiment in that a draft printing mode (test printing) may be set when content to be printed is printed after the printer is recovered from the failure. Other points of a configuration are the same as those of the fourth embodiment.

In the printer 100, as a printing mode of the printer engine 13 (in FIG. 2), a normal printing mode or a draft printing mode may be set. When the “normal printing mode” is set, a printing operation is performed on printing data in accordance with given various printing setting values (printing quality and a size of a sheet for printing, for example). Note that the printing setting values may be input using the operation unit 14 by a user or may be described in script supplied from a DTV 200. On the other hand, when the “draft printing mode” is set, the content to be printed is printed at low cost when compared with the normal printing mode.

Specifically, for example, in the draft printing mode, an amount of ink which is used for printing may be reduced by reducing the number of dots. Furthermore, for example, in the draft printing mode, only one of a plurality of colored inks (for example, C (cyan), M (magenta), Y (yellow), and K (black)) may be used for printing. In such a draft printing mode, although printing quality is deteriorated, the user can roughly recognize the content to be printed. Such a draft printing mode may be set for the following reasons. The user neither recognizes the content to be printed which is supplied from the DTV 200 nor recognizes the size of the sheet for printing and a layout of the content to be printed on the sheet in advance. However, by performing the printing in the draft printing mode (test printing), the user can recognize the content to be printed and the size of the sheet for printing. Note that a printing controller 10b and the printer engine 13 correspond to printing executing unit in Claims.

As with the fourth embodiment described above, when the user specifies one of pieces of content to be printed from a content list screen w2 (in FIG. 9) and presses a print button B33, in this embodiment, a printing operation for printing the content to be printed is started after the content is stored. In step S605 (in FIG. 10), a user interface controller (not shown) controls a display unit 15 (in FIG. 2) to display a test printing determination menu screen.

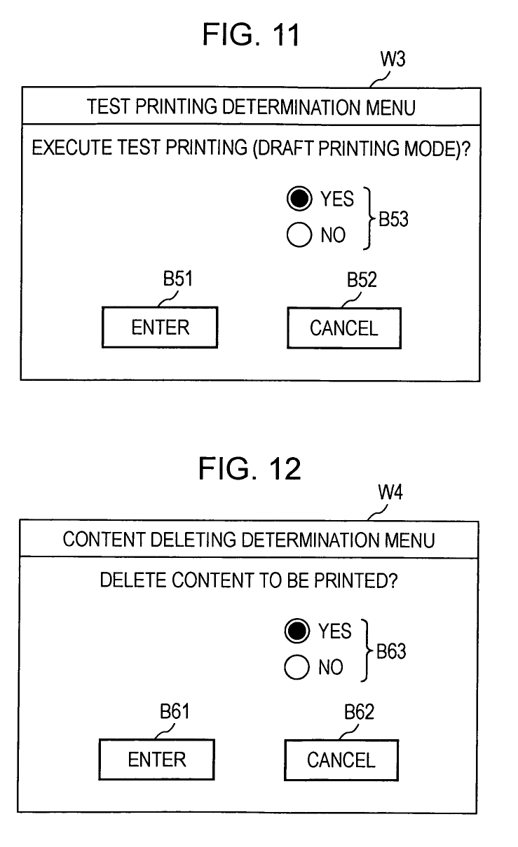

FIG. 11 is a diagram illustrating the test printing determination menu screen displayed in step S605. A test printing determination menu screen W3 includes a radio button group B53 used to determine whether the test printing is performed, an enter button B51, and a cancelling button B52. In an example shown in FIG. 11, “Yes” is selected whereby it is determined that the test printing is performed. In this state, when the enter button B51 is pressed, the selection of “Yes” is confirmed. Note that the test printing determination menu screen W3 corresponds to a second user interface in Claims.

In step S610 (in FIG. 10), the user interface controller (not shown) determines whether “Yes” is selected so that the test printing is determined to be performed. When it is determined that “No” is selected so that the test printing is determined not to be performed, steps S450, S455, S425, S430, and S435 described above are performed in this order. Here, in step S435, the printing controller 10b controls the printer engine 13 to perform a printing operation in a normal printing mode. By this, the content to be printed which is stored in the hard disc drive 12 is printed with relatively high quality.

On the other hand, when it is determined that “Yes” is selected so that the test printing is determined to be performed in step S610 described above, steps S450, S455, S425, and S430 described above are performed in this order, and thereafter, a printing operation in the draft printing mode is performed (in step S435a). Accordingly, the user determines whether the content to be printed which is supplied from the DTV 200 should be printed in the normal printing mode or the content to be printed is stored in the hard disc drive 12 as it is.

Note that in the test printing, the printing controller 10b controls the printer engine 13 not to perform the printing operation using a sheet for printing of a size specified in corrected script but to perform the printing operation using a sheet for printing of a predetermined size which is a relatively large size. Examples of the predetermined size of the sheet for printing include A4, A3, and B4. Such a sheet having a predetermined relatively large size is used for printing for the following reasons. When a sheet for printing having a relatively large size is used, the content to be printed is printed without intruding from the sheet. Therefore, the user recognizes a size of the content to be printed and the user can prepare a sheet for printing of an appropriate size in the printer 100 before the content to be printed is printed in the normal printing mode. Furthermore, even if a size of a special sheet (for example, a glossy sheet of the 2L size) which is relatively expensive is specified as a size of a sheet for printing in the script, a plain sheet (for example, a plain sheet of the A4 size) which is relatively inexpensive may be used for the test printing instead of the special sheet. Consequently, the test printing is performed at low cost.

In step S615, the user interface controller (not shown) controls the display unit 15 (in FIG. 2) to display a content deleting determination menu screen.

FIG. 12 is a diagram illustrating the content deleting determination menu screen displayed in step S615. A content deleting determination menu screen W4 is used to determine whether the content to be printed which is stored in the hard disc drive 12 is deleted. The content deleting determination menu screen W4 includes a radio button group B63 used to determine whether the content to be printed is deleted, an enter button B61, and a cancelling button B62. In an example shown in FIG. 12, “Yes” is selected whereby it is determined that the content to be printed is deleted. The user can check a result of the test printing performed in step S435a so as to determine whether the content to be printed is deleted.

In step S620 (in FIG. 10), the user interface controller (not shown) determines whether “Yes” is selected whereby it is determined that the content to be printed is deleted. When it is determined that “Yes” is selected, the script interpreter 10d (in FIG. 2) deletes the corrected script stored in the script storing unit 12a and image data stored in the image data storing unit 12b (in step S625).

On the other hand, in step S620 described above, when “No” is selected whereby it is determined that the content to be printed is not deleted, the printing operation for printing the content to be printed is terminated. When the user checks the result of the test printing and wishes to print the content with high quality, the printing operation for printing the content to be printed may be performed again. Then, “No” is selected this time (in step S610: No) whereby it is determined that the test printing is not performed in the test printing determination menu screen W3 (in FIG. 11). Consequently, the printing operation is performed in the normal printing mode as described above (in step S435), and the content is printed with relatively high quality.

As described above, in the fifth embodiment, when the content to be printed is printed after the printer 100 is recovered from the failure, the test printing determination menu screen W3 is displayed so that the user determines whether the test printing is performed. Therefore, the user selects “Yes” so that the test printing is determined to be performed, and in accordance with a result of the test printing, the user can further determine whether the content to be printed which is stored in the hard disc drive 12 should be printed with high quality or the content to be printed is deleted. Accordingly, the content which does not need to be printed with high quality is not printed and ink and sheets for printing, for example are prevented from being unnecessarily used. Furthermore, the content which does not need to be stored can be deleted, and therefore, a storage capacity of the hard disc drive 12 is prevented from being unnecessarily used. Moreover, since the test printing is performed at relatively low cost, the printing operation can be performed at low cost when compared with a case where all pieces of content stored in the hard disc drive 12 are printed in the normal printing mode. In addition, since the sheet for printing used in the test printing has a predetermined size and is relatively inexpensive, the test printing can be performed at low cost. Furthermore, since the sheet of a relatively large size is used in the test printing, the user can recognize the size of the content to be printed and prepare a sheet of an appropriate size in the printer 100 before the printing operation in the normal printing mode is performed.

### F. Sixth Embodiment

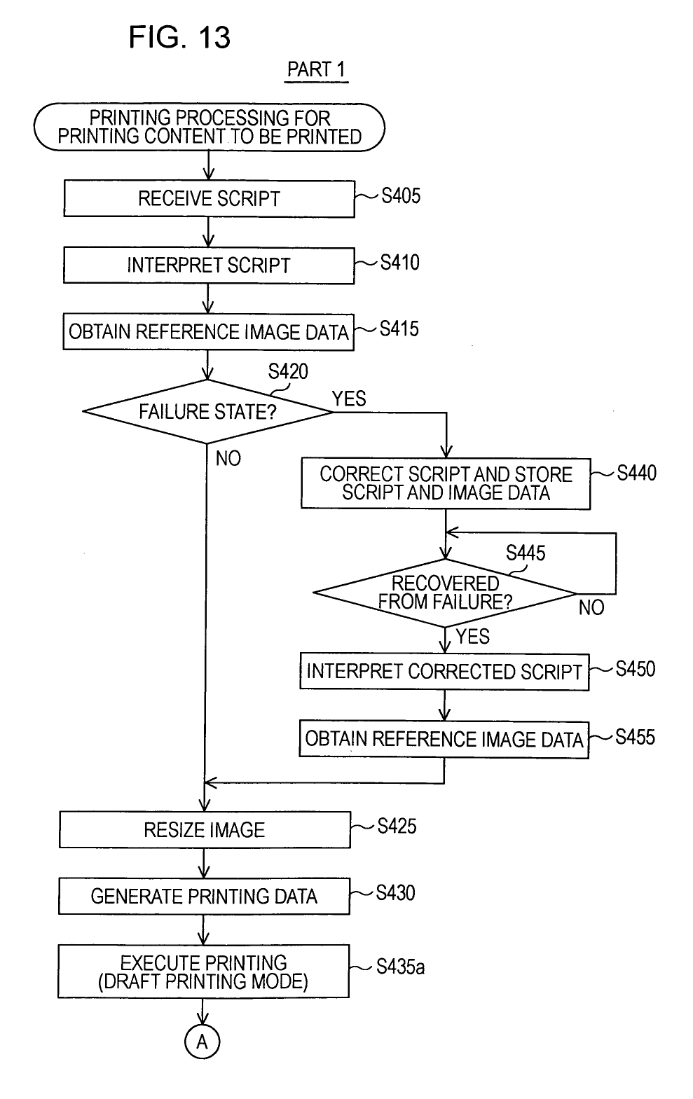

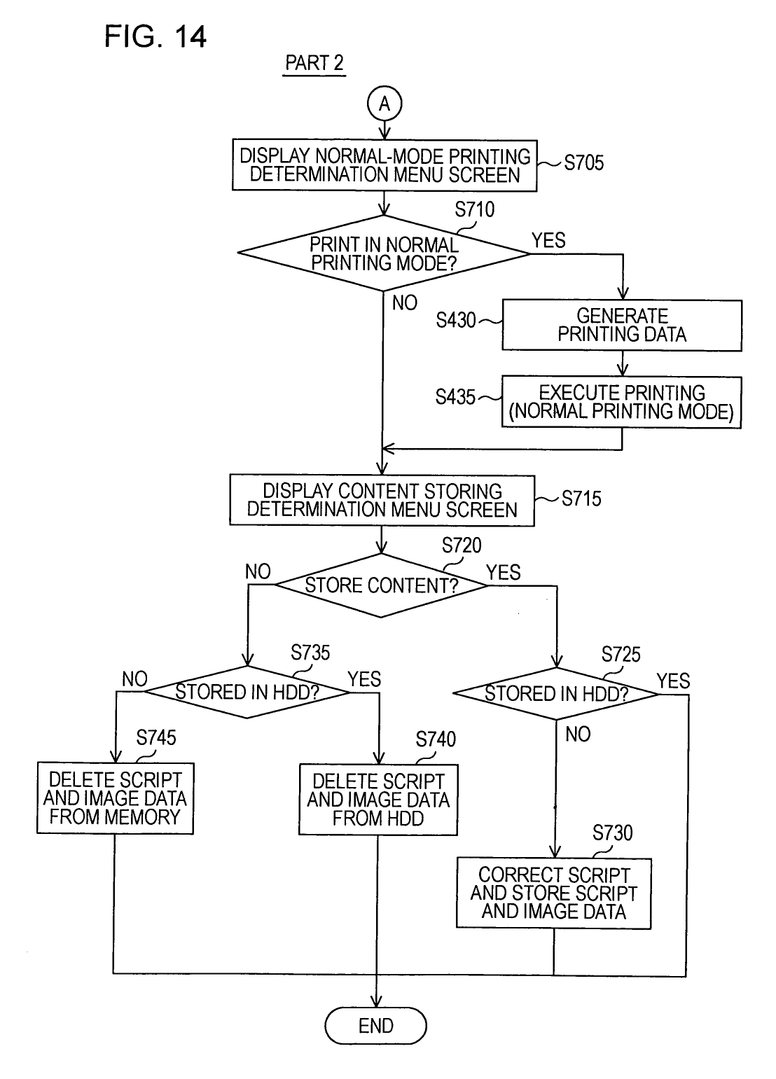

FIGS. 13 and 14 are flowcharts illustrating a procedure of a printing operation for printing content to be printed according to a sixth embodiment. A printer of the sixth embodiment is different from the printer 100 (in FIGS. 2 and 3) in that the printer of the sixth embodiment performs steps S435a instead of step S435 in a printing operation for printing the content to be printed and steps S705 to S745 are additionally performed. Other points of a configuration of the printer of the sixth embodiment are the same as those of the first embodiment. In the first embodiment, the content to be printed is printed in the normal printing mode. However, in the sixth embodiment, the content to be printed is printed in a draft printing mode first, and thereafter, the content to be printed may be printed in a normal printing mode in accordance with a result of a determination made by the user. Note that the “normal printing mode” and the “draft printing mode” of this embodiment are the same as those of the fifth embodiment. Furthermore, in the sixth embodiment, even when a printer 100 is not in a failure state, the content to be printed can be stored.

Specifically, a printing operation is performed in the draft printing mode in step S435a (in FIG. 13). Subsequently, a user interface controller (not shown) controls a display unit 15 (in FIG. 2) to display a printing determination menu screen used to determine whether the printing operation is performed in the normal printing mode.

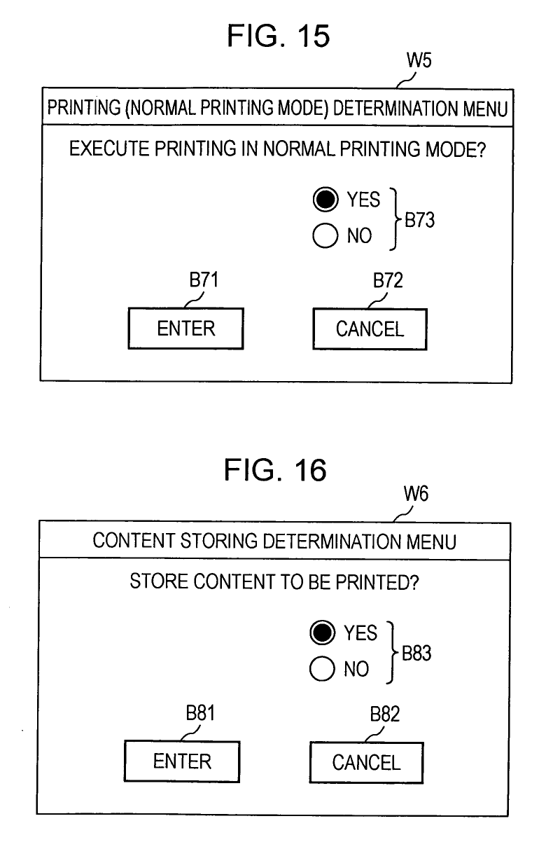

FIG. 15 is a diagram illustrating the printing determination menu screen displayed in step S705. A printing determination menu screen W5 includes a radio button group B73 used to determine whether the printing operation is performed in the normal printing mode, an enter button B71, and a cancelling button B72. In an example shown in FIG. 15, “Yes” is selected whereby it is determined that the printing operation is performed in the normal printing mode.

In step S710 (in FIG. 14), the user interface controller (not shown) determines whether “Yes” is selected so that the printing operation is determined to be performed in the normal printing mode. When it is determined that “Yes” is selected, steps S430 and S435 described above are performed and the content to be printed is printed in the normal printing mode. Note that an image which is printed by the printing operation performed in the normal printing mode may correspond to image data which was resized in step S425 (in FIG. 13).

After step S435 is performed, or when it is determined that “No” is selected so that the printing operation is determined not to performed in the normal printing mode (in step S710: No), the user interface controller (not shown) controls the display unit 15 to display a content storing determination menu screen (in step S715).

FIG. 16 is a diagram illustrating a content storing determination menu screen displayed in step S715. A content storing determination menu W6 is used to determine whether the content to be printed is stored in a hard disc drive 12. The content storing determination menu W6 includes a radio button group B83 used to determine whether the content to be printed is stored, an enter button B81, and a cancelling button B82. In an example shown in FIG. 16, “Yes” is selected whereby it is determined that the content to be printed is stored. Note that the content storing determination menu W6 corresponds to a third user interface in Claims.

In step S720 (in FIG. 14), the user interface controller (not shown) determines whether “Yes” is selected so that it is determined that the content to be printed is stored. When it is determined that “Yes” is selected, the script interpreter 10d (in FIG. 2) determines whether the content to be printed (corrected script and image data) is stored in the hard disc drive 12 (a script storing unit 12a and an image data storing unit 12b) (in step S725).

In a case where the printer 100 is in the failure state, the content to be printed is stored in the hard disc drive 12 in step S440 (in FIG. 13) described above. In this case, the printing operation for printing the content to be printed is terminated (in step S725: Yes). On the other hand, in a case where the printer 100 is not in the failure state, the content to be printed has not been stored in the hard disc drive 12. Therefore, in this case, as with step S440 described above, the script interpreter 10d corrects script and the corrected script is stored in the script storing unit 12a, and furthermore, image data is read from a memory 30 so as to be stored in the image data storing unit 12b (in step S730). As described above, when it is determined that the content to be printed is stored, the content to be printed is newly stored in the hard disc drive 12, or the content to be printed remains in a state being stored in the hard disc drive 12 when the content has already been stored in the hard disc drive 12.

On the other hand, when it is determined that the content to be printed is not stored in step S720 described above, as with step S725, it is determined whether the content to be printed has already been stored in the hard disc drive 12 (in step S735).

In a case where the printer 100 is in the failure state, the content to be printed is stored in the hard disc drive 12 in step S440 (in FIG. 13) described above. Therefore, in this case, the script interpreter 10d deletes the corrected script from the script storing unit 12a and deletes the image data from the image data storing unit 12b (in step S740). On the other hand, in a case where the printer 100 is not in the failure state, the content to be printed has not been stored in the hard disc drive 12. Therefore, in this case, the script interpreter 10d deletes image data and script which is supplied from a DTV 200 and which is temporarily stored in the memory 30 (in step S745). As described above, when it is determined that the content to be printed is not stored, the content to be printed is not stored in the hard disc drive 12, or the content to be printed which has already been stored in the hard disc drive 12 is deleted.

As described above, in the sixth embodiment, since the content to be printed is printed in the draft printing mode first, the user can check a result of the printing in the draft printing mode and determine whether the content to be printed is printed in the normal printing mode or whether the content to be printed is stored. Accordingly, the printer 100 of the sixth embodiment has an advantage the same as that of the printer 100 of the fifth embodiment.

### G. Modifications

Note that among components in the embodiments described above, components other than components claimed in independent claims are additional components and may be omitted as needed. Furthermore, the present invention is not limited to the examples and the embodiments described above, and therefore, the following modification may be made without departing from the scope of the invention.

G1. First Modification

According to the embodiments described above, in the printer 100, the script 301 and the image data 302 are stored in the hard disc drive 12 with their formats remaining unchanged. However, the script 301 and the image data 302 may be converted into data (a file) of another format to be stored. For example, the corrected script 301 and the image data 302 may be converted into a single piece of script of the MIME format to be stored in the hard disc drive 12. Furthermore, the content p1 to be printed (shown in FIGS. 1 and 9) which is obtained by interpreting the corrected script 301 may be stored in the hard disc drive 12 as a single piece of image data (for example, image data compressed by the JPEG format). In this way, the content to be printed can be printed after the printer 100 is recovered from the failure. Furthermore, since the image data which is compressed by the JPEG format is stored as data representing the content to be printed, a large amount of data representing a number of pieces of content to be printed may be stored in the hard disc drive 12 when compared with a case where the corrected script and the image data are stored with their formats remaining unchanged.

G2. Second Modification

According to the embodiments described above, in the printer 100, the script 301 and the image data 302 are stored in their respective storage unit (the script storing unit 12a and the image data storing unit 12b, respectively). However, the script 301 and the image data 302 may be stored in an identical storage unit (content storage unit). Furthermore, the script storing unit 12a and the image data storing unit 12b are included in the hard disc drive 12. However, the script storing unit 12a and the image data storing unit 12b may be included in another arbitrary storage device. For example, the script storing unit 12a and the image data storing unit 12b may be stored in the memory 30. Alternatively, the script storing unit 12a and the image data storing unit 12b may be stored in a memory card which is inserted into a memory card drive (not shown) as long as the printer 100 has the memory card drive.

G3. Third Modification

According to the embodiments described above, only when the printer 100 is in the failure state, the corrected script 301 and the image data 302 are stored in the hard disc drive 12. However, the corrected script 301 and the image data 302 may be stored in the hard disc drive 12 in a case where the printer 100 cannot perform the printing operation immediately (an immediate-printing impossible state) for other reasons. For example, in a case where, while the printer 100 receives a first request for printing from the DTV 200 and performs processing in accordance with the first request for printing, the printer 100 receives a second request for printing from the DTV 200, the printer 100 cannot perform processing in accordance with the second request for printing immediately. Even in such a case, since the corrected script 301 and the image data 302 are stored in the hard disc drive 12, the processing in accordance with the second request for printing is performed so that the content to be printed is printed after the processing performed in accordance with the first request for printing is completed.

Furthermore, the corrected script 301 and the image data 302 may be stored in the hard disc drive 12 both in the immediate-printing impossible state and in a state in which the printing operation can be immediately performed. With this configuration, irrespective of whether the printer 100 is in the immediate-printing impossible state, the content to be printed can be printed again after broadcasting of a program is terminated. Note that, in this configuration, the user can instruct the printing operation by specifying one of pieces of content stored in the hard disc drive 12 using the content list screen W2 (shown in FIG. 9), for example.

G4. Fourth Modification

According to the embodiments described above, the script 301 supplied from the DTV 200 is corrected and stored in the script storing unit 12a in step S440/S440a. However, the script 301 which is not corrected may be stored in the script storing unit 12a along with the corrected script 301.

G5. Fifth Embodiment

According to the first to third embodiments described above, the pieces of data (the script 301 and the image data 302) corresponding to the content to be printed is stored in the hard disc drive 12 even after the printing operation for printing the content to be printed is completed (that is, after an operation in step S435 is completed). However, the pieces of data representing the content to be printed which has been printed may be automatically deleted from the hard disc drive 12 after the operation in step S435 is performed. With this configuration, the capacity of the hard disc drive 12 can be efficiently utilized.

G6. Sixth Modification

According to the embodiments described above, the reference URI of the script 301 (the URI indicated by the <base href> tag) and the relative URI of the reference image data (the URI indicated by the <img src> tag) are corrected. However, only the reference URI may be corrected. Specifically, as show in FIG. 6, although the reference URI is corrected so as to obtain the reference URI “/data/”, the URI of the reference image data (./tmp/IMG001.jpg) may not be corrected. With this configuration, when a directory “/data/tmp/” is not included in the hard disc drive 12, the directory “/data/tmp/” is newly generated so as to store the obtained image data (IMG001.jpg) therein. Even with this configuration, in step S455 (in FIGS. 3 and 7), the UPnP function unit 10e obtains the image data 302 from the hard disc drive 12 in accordance with the corrected script 301.

G7. Seventh Modification

According to the embodiments described above, portions of the configuration realized using hardware may be realized using software instead of the hardware. Conversely, portions of the configuration realized using software may be realized using hardware instead of the software.

G8. Eighth Modification

According to the fifth embodiment, the test printing is available irrespective of an apparatus (control point) which issues a request for printing of the content to be printed. However, the test printing may be available only in a case where a request for printing of the content to be printed is issued from a predetermined type of apparatus, and the printing operation may be performed in the normal printing mode when a request for printing of the content to be printed is issued from another type of apparatus. For example, the test printing may be available for content to be printed corresponding to a request for printing issued by a digital television set. This is because the user cannot preview a result of the printing of the content to be printed on a screen of the digital television set, that is, the user cannot predict the result of the printing. Note that a type of apparatus which issues a request for printing is determined on the basis of description in script used for printing. For example, when a format name indicated by a <documentformat> tag is “inettv-xhtml” in the script, it may be determined that the request for printing is issued from the digital television set. Furthermore, for example, when a tag indicating a request for generation a printing job is <CreatePrintURIjob>, it may be determined that the request for printing is issued from the digital television set whereas when the tag is <CreatePrintJob>, it may be determined that the request for printing is issued from another type of apparatus.

Furthermore, in a case where the test printing has been already performed and the printing operation for printing the content to be printed is performed from the second time on, steps S605 and S610 may be skipped (that is, the test printing determination menu screen W3 is not displayed), and steps S450, S455, S425, S430, and S435 may be performed in this order. Note that, in this case, a flag indicating that the test printing has been already performed is set in a registry (not shown) in the CPU 10 so that it is determined whether the test printing has been performed by turning on/off the flag.

G9. Ninth Modification

According to the sixth embodiment described above, in step S745 (in FIG. 14), the script and the image data which are supplied from the DTV 200 and which are temporarily stored in the memory 30 are deleted. However, the script and the image data supplied from the DTV 200 may be temporarily stored in the hard disc drive 12 irrespective of whether the printer 100 is in the failure state, and when it is determined that the content to be printed is not stored in step S720, step S730 may be skipped and step S740 may be performed so that the script and the image data are deleted from the hard disc drive 12.

G10. Tenth Modification

According to the sixth embodiment described above, in steps S440 and S730, the image data before being resized is stored in the image data storing unit 12b. However, as with the second embodiment, the image data may be stored in the image data storing unit 12b after being resized in advance.

G11. Eleventh Modification

According to the fifth and sixth embodiments described above, when the test printing is performed, notification indicating that the test printing is now in progress may be displayed in the display unit 15 of the printer 100. Accordingly, the user can easily recognize a printing mode used in the printer 100 at the time of the printing operation.

G12. Twelfth Modification

According to the fifth embodiment described above, step S620 may be omitted. In this case, the user can delete the corrected script and the image data which are stored in the hard disc drive 12 by pressing the deleting button B34 in the content list screen W2 (shown in FIG. 9).

1. A printing apparatus which prints content including an image, the printing apparatus comprising:
an obtaining unit configured to obtain script which describes about the content in accordance with the XML standard and reference image data which is referred by the script;
a script interpreter configured to interpret the script; and
a content storing unit,
wherein the obtaining unit obtains the reference image data from a reference destination in accordance with a result of interpreting of the script obtained using the script interpreter when receiving a request for printing including the script, and
the script interpreter corrects the script so that the reference destination of the reference image data is changed to the content storing unit, and the corrected script and the reference image data are stored in the content storing unit.

2. The printing apparatus according to claim 1, further comprising:
a management unit configured to manage an operation state of the printing apparatus,
wherein the script interpreter obtains the operation state of the printing apparatus from the management unit, and when the printing apparatus is in an immediate-printing impossible state in which the printing apparatus cannot perform processing immediately in accordance with the request for printing, the corrected script and the reference image data are stored in the content storing unit, whereas when the printing apparatus is not in the immediate-printing impossible state, the corrected script and the reference image data are not stored in the content storing unit.

3. The printing apparatus according to claim 2,
wherein the immediate-printing impossible state is a failure state.

4. The printing apparatus according to claim 1,
wherein the content storing unit stores the corrected script and the reference image data even after the content is printed.

5. The printing apparatus according to claim 4, further comprising:
an image processor configured to resize an image represented by the reference image data in accordance with a size of a sheet for printing specified by the request for printing,
wherein the script interpreter controls the content storing unit to store therein image data representing the resized image as the reference image data.

6. The printing apparatus according to claim 5, further comprising:
a first user interface including a content list display unit used to display a list of pieces of content each of which includes the corrected script and the reference image data which are stored in the content storing unit, a button used to print one of the pieces of content selected from the list, and a button used to delete the corrected script and the reference image data of the one of the pieces of content selected from the list.

7. The printing apparatus according to claim 6, further comprising:
a printing executing unit configured to print the content in accordance with the result of interpreting of the script obtained using the script interpreter; and
a second user interface,
wherein the printing executing unit includes as printing modes used when the content is printed,
(i) a normal printing mode, and
(ii) a draft printing mode which attains printing cost lower than that of the normal printing mode, and
the second user interface is used to select one of the printing modes.

8. The printing apparatus according to claim 6, further comprising:
a printing executing unit configured to print the content in accordance with the result of interpreting of the script obtained using the script interpreter; and
a third user interface,
wherein the printing executing unit includes as printing modes used when the content is printed,
(i) a normal printing mode, and
(ii) a draft printing mode which attains printing cost lower than that of the normal printing mode, and
the third user interface is used to determine whether the corrected script and the reference image are stored in the content storing unit after the printing executing unit prints the content in the draft printing mode.

9. The printing apparatus according to claims 7 or 8,
wherein the printing executing unit performs printing using a predetermined sheet for printing of a relatively large size irrespective of a size of a sheet for printing specified by the request for printing when printing the content in the draft printing mode.

10. A content printing method for printing content including an image using a printing apparatus including a content storing unit, the content printing method comprising the steps of:
(a) receiving a request for printing including script describing about the content in accordance with the XML standard;
(b) interpreting the script;
(c) obtaining reference image data which is referred by the script from a reference destination in accordance with a result of interpreting of the script; and
(d) correcting the script so that the reference destination of the reference image data is changed to the content storing unit and storing the corrected script and the reference image data in the content storing unit.
